(19) United States
(12) Patent Application Publication
(10) Pub. No.: US 2021/0213941 A1
(43) Pub. Date: Jul. 15, 2021

(54) Vehicle Control Device

(71) Applicant: Hitachi Automotive Systems, Ltd., Hitachinaka-shi, Ibaraki (JP)

(72) Inventors: Yoshitaka FUKASAWA, Hitachinaka-shi (JP); Yusuke KOGURE, Hitachinaka-shi (JP); Masashi SEIMIYA, Hitachinaka-shi (JP); Tomoyasu SAKAGUCHI, Hitachinaka-shi (JP); Satoshi MATSUDA, Hitachinaka-shi (JP)

(21) Appl. No.: 17/268,358

(22) PCT Filed: Aug. 8, 2019
(86) PCT No.: PCT/JP2019/031324

§ 371 Date: Feb. 12, 2021

(30) Foreign Application Priority Data
Sep. 27, 2018 (JP) 2018-182401

(51) Int. Cl. B60W 30/06; B60W 10/04; B60W 10/18; B60W 30/09

(52) U.S. Cl. CPC B60W 30/06; B60W 10/04; B60W 10/18; B60T 7/12; B60W 2720/106; B60W 2720/125; B60W 2710/18; B60W 30/09

(57) ABSTRACT

Provided is a vehicle control device capable of improving the riding comfort of a vehicle during parking control. A vehicle control device 10 includes: a distance measuring unit 14 that measures a distance between a position of a vehicle and a target stop position of the vehicle; and an acceleration setting unit 15 that sets an acceleration profile, which is a time change of a target value of acceleration during deceleration of the vehicle, according to the distance based on a jerk profile 15a, which is a time change of a target value of jerk during deceleration of the vehicle.

### TECHNICAL FIELD

The present disclosure relates to a vehicle control device that controls parking of a vehicle.

### BACKGROUND ART

Conventionally, inventions relating to a driving support system for supporting the driving of a vehicle from a traveling start position to a stopped position have been known (see PTL 1 below). The driving support system described in PTL 1 includes a start position information acquisition unit, a stop position information acquisition unit, a travel route setting unit, a distance computing unit, a travel distance information acquisition unit, a remaining distance computing unit, a determination unit, and a speed control unit (see claim 1 and the like of the same literature).

The start position information acquisition unit acquires start position information indicating a travel start position of the vehicle. The stop position information acquisition unit continuously acquires stop position information indicating a stop position at which the vehicle is to be stopped. The travel route setting unit sets a travel route from the travel start position to the stop position based on the start position information and the stop position information. The distance computing unit continuously computes the distance from the travel start position to the stop position along the travel route.

The travel distance information acquisition unit continuously acquires travel distance information indicating the actual distance traveled while the vehicle is traveling from the travel start position to the stop position. The remaining distance computing unit continuously computes the remaining distance, which is a distance from a current position of the vehicle to the stop position, based on the distance computed by the distance computing unit and the travel distance information.

The determination unit continuously determines whether or not the remaining distance is equal to or shorter than a preset deceleration start distance at which the vehicle starts decelerating. The speed control unit reduces the speed of the vehicle when the remaining distance is equal to or shorter than the deceleration start distance.

With such a configuration, even if the stop position is changed after the vehicle starts traveling, the remaining distance, which is the distance from the current position of the vehicle to the stop position, can be continuously computed. Then, by appropriately controlling a brake and an accelerator according to the magnitude relationship between the computing result of the remaining distance and the preset deceleration start distance, it is possible to prevent an occupant from feeling uncomfortable or fearful. Therefore, according to this driving support system, it is possible to stop the vehicle at the changed stop position without impairing the riding comfort of the occupant of the vehicle (see paragraph 0009 and the like of the same literature).

### CITATION LIST

### Patent Literature

PTL 1: JP 2018-20590 A

### SUMMARY OF INVENTION

### Technical Problem

In the conventional driving support system, the speed control unit generates a speed command value as a speed target value from an acceleration command value (see paragraph 0032 and the like of PTL 1). However, in this conventional driving support system, as illustrated in FIG. 2 of the same literature, the acceleration command value changes in a discontinuous step shape. Therefore, the impact due to the inertial force acting on the occupant during deceleration of the vehicle becomes large, and the riding comfort of the vehicle during parking control may be deteriorated.

The present disclosure provides a vehicle control device capable of improving the riding comfort of a vehicle during parking control.

### Solution to Problem

According to one aspect of the present disclosure, there is provided a vehicle control device, including: a distance measuring unit that measures a distance between a position of a vehicle and a target stop position of the vehicle; and an acceleration setting unit that sets an acceleration profile, which is a time change of a target value of acceleration during deceleration of the vehicle, according to the distance based on a jerk profile, which is a time change of a target value of jerk during deceleration of the vehicle.

### Advantageous Effects of Invention

According to the present disclosure, it is possible to provide the vehicle control device capable of improving the riding comfort of the vehicle during parking control.

### BRIEF DESCRIPTION OF DRAWINGS

FIG. 1 is a schematic configuration diagram of a vehicle on which a vehicle control device according to an embodiment of the present disclosure is mounted.

FIG. 2 is a functional block diagram of the vehicle control device mounted on the vehicle illustrated in FIG. 1.

FIG. 3 is a plan view illustrating an example of parking control of the vehicle by the vehicle control device illustrated in FIG. 2.

FIG. 4 is a graph showing an example of a jerk profile in an acceleration setting unit illustrated in FIG. 2.

FIG. 5 is a graph showing the time change of the acceleration, speed, and distance of the vehicle illustrated in FIG. 3.

FIG. 6 is a flow chart illustrating an example of parking control of the vehicle by the vehicle control device illustrated in FIG. 2.

FIG. 7 is a plan view illustrating another example of parking control of the vehicle by the vehicle control device illustrated in FIG. 2.

FIG. 8 is a flow chart of parking control of the vehicle by the vehicle control device in the example illustrated in FIG. 7.

FIG. 9 is a graph showing the time change of the acceleration, speed, and distance of the vehicle illustrated in FIG. 7.

### DESCRIPTION OF EMBODIMENTS

Hereinafter, embodiments of a vehicle control device according to the present disclosure will be described with reference to the drawings.

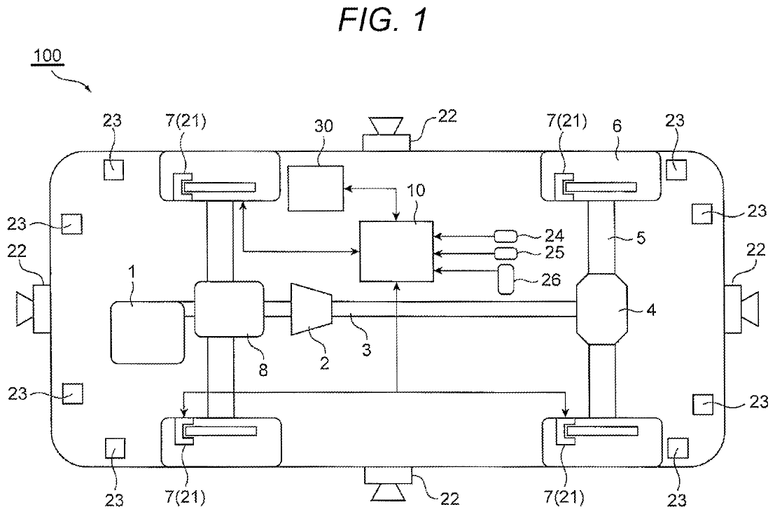

FIG. 1 is a schematic configuration diagram of a vehicle 100 on which a vehicle control device 10 according to an embodiment of the present disclosure is mounted. The vehicle 100 includes, for example, an in-cylinder injection gasoline engine 1 as a power source for traveling and an automatic transmission 2 that can be connected to and detached from the engine 1.

FIG. 1 illustrates an example of the vehicle 100 on which the vehicle control device 10 is mounted, and does not limit the configuration of the vehicle 100. For example, the vehicle 100 may use a motor or an engine and a motor as a driving power source instead of the engine 1. Further, the vehicle 100 may adopt a continuously variable transmission (CVT) instead of the automatic transmission 2.

The vehicle 100 is a rear wheel drive vehicle having a typical configuration including, for example, a propeller shaft 3, a differential gear 4, a drive shaft 5, four wheels 6, a hydraulic brake 7 including a wheel speed sensor 21, and an electric power steering 8.

The vehicle 100 includes the vehicle control device 10. The vehicle control device 10 is a device that controls devices, actuators, and machines mounted on the vehicle 100. The vehicle control device 10 and the devices, the actuators, and the machines including sensors described later are configured to be able to exchange signals and data through an in-vehicle LAN and CAN communication. The vehicle control device 10 is, for example, an electronic control unit (ECU), and is a parking assistance ECU and a vehicle control ECU.

The vehicle 100 includes, for example, a plurality of wheel speed sensors 21, a plurality of monocular cameras 22, and a plurality of sonars 23 as sensors. The wheel speed sensor 21 generates a pulse waveform according to the rotation of the wheel and transmits it to the vehicle control device 10. The plurality of monocular cameras 22 and the plurality of sonars 23 are, for example, external recognition sensors that are arranged at the front, rear, and sides of the vehicle 100 and detect obstacles and road information around the vehicle.

Further, the vehicle 100 includes, for example, sensors 24, 25, and 26 as operation amount detection sensors that detect operation amounts (steering angles) of a brake pedal, an accelerator pedal, a steering wheel, respectively. In addition to the above sensors, the vehicle 100 may include, for example, a sensor such as a stereo camera or LIDAR (Light Detection and Ranging; Laser Imaging Detection and Ranging) as an external recognition sensor. Further, the vehicle 100 may include a seating sensor that detects the presence or absence of an occupant.

The vehicle control device 10 acquires information on the outside of the vehicle 100 and the operation amounts of the brake pedal, the accelerator pedal, and the steering wheel at respective parts of the vehicle 100 from the various sensors described above. Based on the acquired information, the vehicle control device 10 sends command values for achieving following the preceding vehicle, maintaining the center of the white line, preventing lane departure, automatic parking, etc., to the engine 1, the automatic transmission 2, the brake 7, the electric power steering 8, etc.

The vehicle 100 includes, for example, a display device 30. The display device 30 is, for example, a liquid crystal display device provided with a touch panel, and is an image information output device that displays an image by the vehicle control device 10 and notifies the occupants of the information. Further, the display device 30 also functions as an information input device for the occupant of the vehicle 100 to input information to the vehicle control device 10 by providing the touch panel.

Further, the vehicle 100 includes, for example, a microphone and a speaker (not shown).

The microphone is a voice information input device for the occupant of the vehicle 100 to input information by voice to the vehicle control device 10. Further, the speaker is a voice information output device that notifies the occupant of the vehicle 100 of information by electronic sounds or voices by the vehicle control device 10.

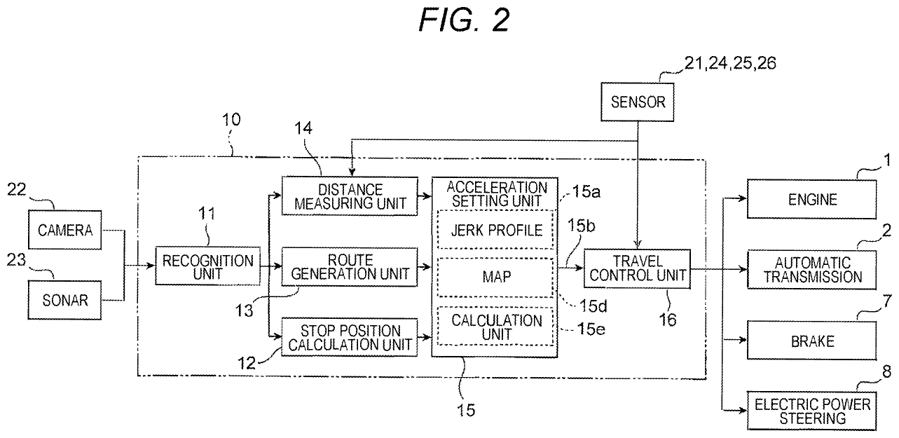

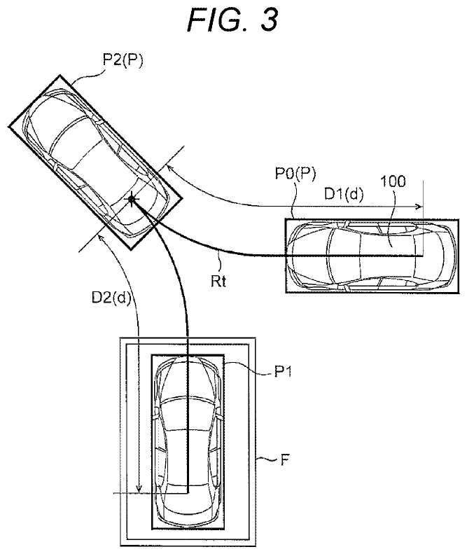

FIG. 2 is a functional block diagram of the vehicle control device 10 according to the present embodiment. FIG. 3 is a plan view illustrating an example of parking control by the vehicle control device 10 illustrated in FIG. 2.

Each part of the vehicle control device 10 is configured by, for example, a computer unit including a central processing unit (CPU), a storage device such as a memory, a computer program stored in the storage device, and an input/output unit for transmitting and receiving data and signals. Although the details will be described later, the vehicle control device 10 of the present embodiment is characterized by the following configurations. In the present embodiment, a target route Rt of the vehicle 100 is illustrated as, for example, the locus of the center of the axle of the rear wheels.

The vehicle control device 10 of the present embodiment includes a distance measuring unit 14 and an acceleration setting unit 15. The distance measuring unit 14 measures a distance D1(D2) between a current position P of the vehicle 100 and a target stop position P2(P1) of the vehicle 100. The acceleration setting unit 15 sets an acceleration profile according to the distance D1 (D2) based on a jerk profile 15a. Here, the jerk profile 15a is a time change of the target value of jerk during deceleration of the vehicle 100, and the acceleration profile is a time change of the target value of acceleration during deceleration of the vehicle 100.

Hereinafter, the configuration of each part of the vehicle control device 10 will be described in more detail. The vehicle control device 10 includes, for example, a recognition unit 11, a stop position calculation unit 12, a route generation unit 13, and a travel control unit 16 in addition to the distance measuring unit 14 and the acceleration setting unit 15 described above.

The recognition unit 11 recognizes obstacles around the vehicle 100. More specifically, the recognition unit 11 recognizes obstacles and road information around the vehicle 100 based on signals input from, for example, the monocular cameras 22 and the sonars 23 of the vehicle 100. Obstacles recognized by the recognition unit 11 include, for example, moving objects such as other vehicles and pedestrians around the vehicle 100, parked vehicles around the vehicle 100, curbs, guardrails, walls, pillars, poles, road signs, and the like. Further, the road information recognized by the recognition unit 11 includes, for example, a road shape, a road marking, a parking frame F, a space in which the vehicle 100 can be parked, and the like.

The stop position calculation unit 12 calculates the target stop positions P1 and P2 of the vehicle 100 based on, for example, the recognition result of the recognition unit 11 and the target route Rt generated by the route generation unit 13. More specifically, the stop position calculation unit 12 calculates, for example, the target stop position P1 which is a parking position of the vehicle 100 in a space where the vehicle 100 recognized by the recognition unit 11 can be parked.

Further, the stop position calculation unit 12 calculates, for example, the target stop position P2 which is a turning position of the target route Rt generated by the route generation unit 13. The turning position is a connection position between the forward route and the reverse route in the target route Rt, or a position that is a boundary between the forward route and the reverse route. The forward route of the target route Rt is a route for the vehicle 100 to move forward, and the reverse route of the target route Rt is a route for the vehicle 100 to move backward. Further, the stop position calculation unit 12 can calculate a stop position P3 (see FIG. 7) for avoiding a collision with an obstacle O based on the recognition result of the recognition unit 11.

The route generation unit 13 generates the target route Rt from a parking start position P0 of the vehicle 100 to the target stop position P1 or P2. More specifically, the route generation unit 13 generates the target route Rt from the parking start position P0 of the vehicle 100 to the target stop position P1 where the vehicle 100 can be parked, based on the recognition result of the recognition unit 11. The target route Rt has, for example, the target stop position P2 as a turning position for switching between the forward movement and the reverse movement of the vehicle 100. For example, when the vehicle 100 is moved forward and parked at the target stop position P1, or when the vehicle 100 is parked only in reverse, the target route Rt may not have the target stop position P2 which is a turning position.

The distance measuring unit 14 measures a distance d between the position P of the vehicle 100 and the target stop position P1 or P2 of the vehicle 100. More specifically, the distance measuring unit 14 calculates, for example, the current position P of the vehicle 100 traveling on the target route Rt generated by the route generation unit 13 based on information input from the monocular cameras 22, the wheel speed sensors 21, or the like. Further, the distance measuring unit 14 calculates, for example, the distance d to the target stop position P1 or P2 along the target route Rt, that is, the remaining distance based on the current position P of the vehicle 100 and the target stop position P1 or P2 in real time at a predetermined cycle.

The acceleration setting unit 15 includes, for example, the jerk profile 15a, a map 15d, and a computing unit 15e. As described above, the acceleration setting unit 15 sets the acceleration profile during deceleration of the vehicle 100 based on the jerk profile 15a according to the distances D1 and D2 calculated by the distance measuring unit 14.

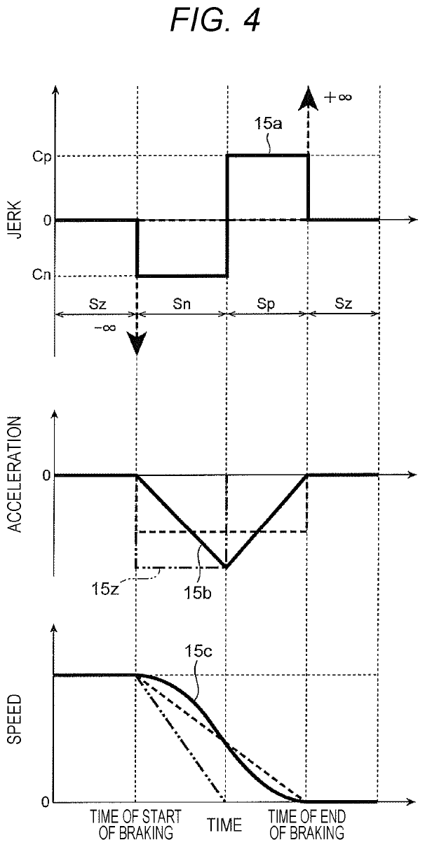

FIG. 4 is a graph showing an example of the jerk profile 15a, the acceleration profile 15b, and a speed profile 15c from the top. In each graph of FIG. 4, for comparison, the profile of the present embodiment is indicated by a solid line, and the profile in a conventional driving support system is indicated by a broken line. As shown at the top of FIG. 4, the jerk profile 15a is, for example, a waveform representing the time change of the target value of jerk during deceleration of the vehicle 100, where the vertical axis is the jerk and the horizontal axis is the time.

The jerk profile 15a has, for example, a section Sp in which the target value of jerk is a positive constant value Cp. Further, the jerk profile 15a has, for example, a section Sn in which the target value of jerk is a negative constant value Cn. Further, the jerk profile 15a has, for example, a section Sz in which the target value of jerk is 0. Further, in the jerk profile 15a, for example, the absolute value of the positive constant value Cp and the absolute value of the negative constant value Cn are equal to each other.

Based on such a jerk profile 15a, the acceleration setting unit 15 sets the acceleration profile 15b during deceleration of the vehicle 100 according to the distance d between the position P of the vehicle 100 and the target stop position P1 or P2 calculated by the distance measuring unit 14. In the example shown in FIG. 4, the acceleration profile 15b set by the acceleration setting unit 15 based on the jerk profile 15a is continuous. More specifically, the acceleration profile 15b set by the acceleration setting unit 15 is continuous, for example, before and after the start of braking when the speed starts to decrease. Further, the acceleration profile 15b set by the acceleration setting unit 15 is continuous, for example, before and after the end of braking when the speed becomes 0.

Here, the acceleration profile of the conventional driving support system indicated by the broken line for comparison has a stepped waveform. That is, this conventional acceleration profile is discontinuous before and after the start of braking when the speed begins to decrease. Further, this conventional acceleration profile is discontinuous before and after the end of braking when the speed becomes 0. In this conventional driving support system, the jerk of the vehicle becomes negative infinity (−∞) at the start of braking and positive infinity) (+∞) at the end of braking, as indicated by the broken line in the graph at the top of FIG. 4.

That is, the acceleration profile of the conventional driving support system is not a profile based on the jerk profile, but a step-like profile independent of the jerk profile. If the acceleration profile of the vehicle is such a step-like profile, the acceleration acting on the occupant during the parking control of the vehicle becomes excessive, and the occupant may receive a strong impact due to the inertial force, which may deteriorate the riding comfort of the vehicle.

The jerk profile 15a is not limited to the example shown in FIG. 4. For example, in an acceleration section Za of the target route Rt described later, the jerk profile 15a may be a profile that becomes the positive constant value Cp after the start of the acceleration section Za and the negative constant value Cn before the end of the acceleration section Za. Further, in a deceleration section Zd of the target route Rt described later, the jerk profile 15a may be, for example, a profile that becomes the negative constant value Cn for a certain period of time immediately after the start of deceleration, becomes zero (0) for a certain period of time, and then becomes the positive constant value Cp for a certain period of time.

The acceleration setting unit 15 includes, for example, the map 15d that records the relationship between the parking start position P0 of the vehicle 100, the target stop positions P1 and P2, and the jerk profile 15a.

In this case, the acceleration setting unit 15 derives, for example, the parking start position P0 of the vehicle 100 and the jerk profile 15a corresponding to the target stop position P1 or P2 calculated by the stop position calculation unit 12 from the map 15d. Then, the acceleration setting unit 15 can set the acceleration profile 15b according to the distance between the position P of the vehicle 100 and the target stop position P1 or P2 based on the jerk profile 15a derived from the map 15d.

Further, the acceleration setting unit 15 includes, for example, a computing unit 15e that calculates the acceleration profile 15b. In this case, the acceleration setting unit 15 can, for example, calculate the jerk profile 15a by the computing unit 15e, and further set the acceleration profile 15b calculated by the computing unit 15e using the jerk profile 15a. Further, the acceleration setting unit 15 is configured to set an emergency acceleration profile 15z independent of the jerk profile 15a in an emergency requiring a sudden stop, for example.

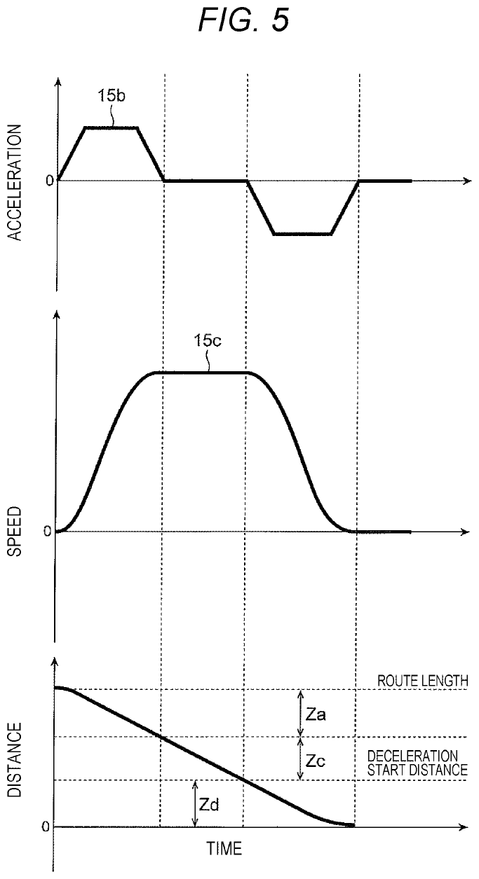

The travel control unit 16 controls the engine 1, the automatic transmission 2, the brake 7, the electric power steering 8, etc. by controlling various actuators, for example, to cause the vehicle 100 to travel according to the acceleration profile 15b and the target route Rt. For example, the travel control unit 16 calculates the speed profile 15c of the vehicle 100 based on the acceleration profile 15b set by the acceleration setting unit 15. The integrated value of this speed profile 15c is the travel distance of the vehicle 100. For example, the travel control unit 16 calculates the acceleration section Za, a constant speed section Zc, and the deceleration section Zd (see FIG. 5) in the target route Rt by integrating the speed profile 15c, and starts braking the vehicle 100 at the start position of the deceleration section Zd.

Hereinafter, the operation of the vehicle control device 10 of the present embodiment will be described.

FIG. 5 is a graph showing the time change of the acceleration and speed of the vehicle 100 and the distance d from the position P of the vehicle 100 to the target stop position P1 or the target stop position P2 in the example of parking control of the vehicle 100 illustrated in FIG. 3.

For example, it is assumed that the occupant is driving the vehicle 100 looking for a parking space. At this time, the vehicle control device 10 recognizes a parkable space around the vehicle 100 by, for example, the monocular cameras 22, the sonars 23, and the recognition unit 11. Further, the vehicle control device 10 displays the recognized parkable space on the display device 30, for example, so as to be superimposed on the road information around the vehicle control device 10.

For example, the occupant of the vehicle 100 confirms the parkable space displayed on the display device 30, and stops the vehicle 100 at the parking start position P0 as illustrated in FIG. 3. Then, the vehicle control device 10 calculates, for example, the target stop position Pl, which is the parking position of the vehicle 100 in the parkable space by the stop position calculation unit 12. Further, the vehicle control device 10 generates, for example, the target route Rt from the parking start position P0 to the target stop position P1 by the route generation unit 13.

Further, the vehicle control device 10 calculates, for example, the target stop position P2, which is the turning position of the target route Rt, by the stop position calculation unit 12. Further, the vehicle control device 10 sets, for example, the acceleration profile 15b, which is the time change of the target value of the acceleration of the vehicle 100, as shown in FIG. 5 by the acceleration setting unit 15 based on the jerk profile 15a, which is the time change of the jerk target value of the vehicle 100.

At this time, the acceleration setting unit 15 sets the acceleration profile 15b according to, for example, each of the distance D1 from the parking start position P0 to the target stop position P2 and the distance D2 from the target stop position P2 to the target stop position P1. More specifically, the acceleration setting unit 15 sets the acceleration profile 15b on the forward route from the parking start position P0 to the target stop position P2, which is the turning position of the target route Rt. Further, the acceleration setting unit 15 sets the acceleration profile 15b on the reverse route from the target stop position P2, which is the turning position of the target route Rt, to the target stop position P1, which is the parking position.

After that, when the occupant of the vehicle 100 selects, for example, the automatic parking control by operating the touch panel of the display device 30 and releases the brake 7, the automatic parking control of the vehicle 100 by the vehicle control device 10 is started. Then, the travel control unit 16 calculates the speed profile 15c based on the acceleration profile 15b set by the acceleration setting unit 15. Then, the travel control unit 16 controls the engine 1, the automatic transmission 2, the brake 7, and the electric power steering 8 to cause the vehicle 100 to travel according to the jerk profile 15a and the target route Rt.

As a result, as shown in FIG. 5, in the acceleration section Za of the target route Rt, the vehicle 100 is accelerated by the continuous acceleration profile 15b based on the jerk profile 15a, and accelerated by the quadratic curve smooth speed profile 15c. More specifically, the acceleration profile 15b during acceleration of the vehicle 100 can be expressed, for example, as a differentiable and continuous function before and after the start of acceleration.

As a result, the vehicle 100 starts smoothly from the parking start position P0, the inertial force acting on the occupant when the vehicle 100 is accelerated is reduced, and the riding comfort of the vehicle 100 during parking control is improved. After that, the vehicle control device 10 is caused to travel at a constant speed in the constant speed section Zc of the target route Rt. The target route Rt may not have the constant speed section Zc when the distance D1 from the parking start position P0 to the target stop position P2 is short.

On the other hand, the conventional driving support system has a stepped and discontinuous acceleration profile as indicated by the broken line in FIG. 4. More specifically, the acceleration profile of the conventional driving support system can be expressed as a non-differentiable and discontinuous function before and after the start of acceleration. Therefore, in the conventional driving support system, the jerk becomes positive infinity (+∞) at the start of acceleration of the vehicle, and the acceleration increases stepwise. Therefore, the impact caused by the momentary increase in the inertial force acting on the occupant becomes large, and the riding comfort of the vehicle at the time of parking control may be deteriorated.

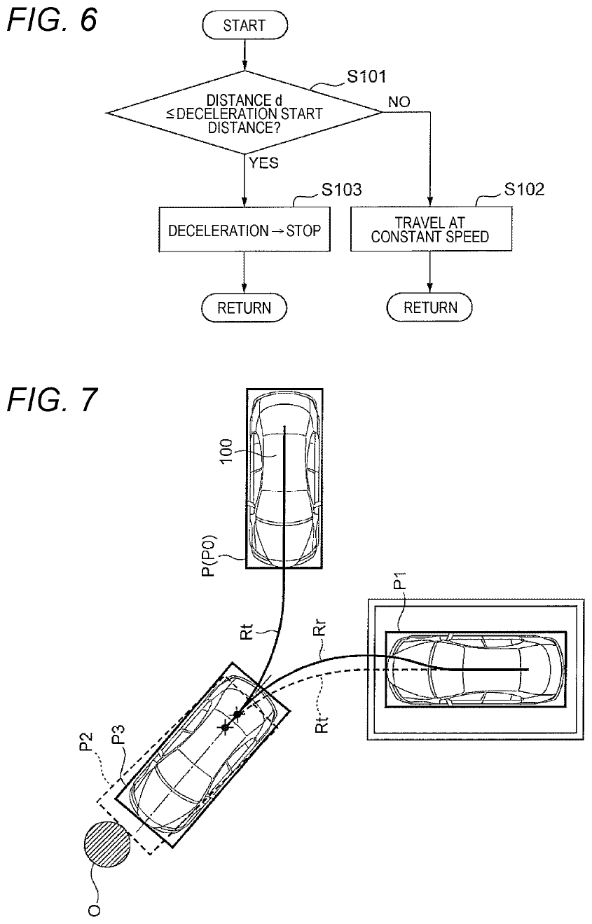

FIG. 6 is a flow chart illustrating an example of parking control of the vehicle 100 by the vehicle control device 10 of the present embodiment. FIG. 6 illustrates the flow when the vehicle 100 shifts from the constant speed section Zc to the deceleration section Zd of the target route Rt shown in FIG. 5.

In step S101, for example, it is assumed that the vehicle 100 is moving forward on the forward route before the target stop position P2, which is the turning position of the target route Rt.

In this case, the vehicle control device 10 measures the distance d from the current position P of the vehicle 100 to the target stop position P2, that is, the remaining distance to the target stop position P2 by the distance measuring unit 14.

Further, in step S101, it is assumed that the vehicle 100 is moving backward on the reverse route ahead of the target stop position P2, which is the turning position of the target route Rt. In this case, in step S101, the vehicle control device 10 measures the distance d from the current position P of the vehicle 100 to the target stop position P1, which is the parking position, that is, the remaining distance to the target stop position P1 by the distance measuring unit 14.

Further, in step S101, the vehicle control device 10 determines whether or not the distance d is equal to or shorter than the deceleration start distance by, for example, the travel control unit 16. Here, the deceleration start distance is, for example, the distance of the deceleration section Zd before the target stop position P2 in the forward route of the target route Rt, and the distance of the deceleration section Zd before the target stop position P1 in the reverse route of the target route Rt.

In step S101, for example, when the travel control unit 16 determines that the distance d is longer than the deceleration start distance, that is, the distance d is not equal to or shorter than the deceleration start distance (NO), the process proceeds to step S102. In step S102, the vehicle control device 10 causes the vehicle 100 to travel at a constant speed by the travel control unit 16, and the process returns to step S101.

On the other hand, in step S101, for example, when the travel control unit 16 determines that the distance d is equal to or shorter than the deceleration start distance (YES), the process proceeds to step S103. In step S103, the vehicle control device 10 decelerates the vehicle 100 by the travel control unit 16 and stops the vehicle 100 at the target stop position P1 or P2.

Here, as described above, the vehicle control device 10 of the present embodiment includes the distance measuring unit 14 that measures the distance d between the position P of the vehicle 100 and the target stop position P1 or P2. Further, the vehicle control device 10 includes the acceleration setting unit 15 that sets the acceleration profile 15b, which is a time change of the target value of acceleration during deceleration of the vehicle 100, according to the distance d based on the jerk profile 15a, which is a time change of the target value of jerk during deceleration of the vehicle 100.

With this configuration, the vehicle 100 is decelerated by the continuous acceleration profile 15b based on the jerk profile 15a in the deceleration section Zd before the target stop position P1 or P2 in the target route Rt, as shown in FIG. 4.

As a result, as shown in FIG. 5, the vehicle 100 is decelerated by the continuous acceleration profile 15b based on the jerk profile 15a in the deceleration section Zd of the target route Rt, and decelerated by the quadratic curve smooth speed profile 15c. More specifically, the acceleration profile 15b during deceleration of the vehicle 100 can be expressed, for example, as a differentiable and continuous function before and after the stop of the vehicle 100, that is, the end of deceleration. As a result, the vehicle control device 10 can gradually increase or decrease the inertial force acting on the occupant at the start and end of braking of the vehicle 100 to alleviate the impact and improve the riding comfort of the vehicle 100 during parking control.

On the other hand, in the conventional driving support system, the jerk of the vehicle becomes negative infinity (−∞) at the start of braking of the vehicle, becomes 0 during braking of the vehicle, and becomes positive infinity (+∞) at the end of braking of the vehicle, that, is at the stop, as indicated by the broken line in FIG. 4. As a result, the acceleration profile of the conventional driving support system becomes a non-differentiable and discontinuous step-like function before and after the start of braking and before and after the end of braking of the vehicle. Therefore, in the conventional driving support system, the impact caused by the momentary and rapid increase/decrease in the inertial force acting on the occupant at the start and end of braking of the vehicle 100 becomes large, and the riding comfort of the vehicle during parking control may be deteriorated.

Further, in the vehicle control device 10 of the present embodiment, the jerk profile 15a included in the acceleration setting unit 15 has the section Sp in which the target value of jerk is the positive constant value Cp.

As a result, the negative acceleration of the vehicle 100 can be gradually increased to approach 0 before the target stop position P1 or P2, the inertial force acting on the occupant when the vehicle 100 is stopped is reduced, and the riding comfort of vehicle 100 during parking control is improved.

Further, in the vehicle control device 10 of the present embodiment, the jerk profile 15a included in the acceleration setting unit 15 has the section Sn in which the target value of jerk is the negative constant value Cn.

As a result, after the start of the deceleration section Zd, that is, after the start of deceleration, the negative acceleration can be gradually reduced to approach the minimum value, the inertial force acting on the occupant at the start of deceleration of the vehicle 100 is reduced, and the riding comfort of the vehicle 100 during parking control is improved.

Further, in the vehicle control device 10 of the present embodiment, the jerk profile 15a included in the acceleration setting unit 15 has the section Sz in which the target value of jerk is 0. Thereby, for example, the vehicle 100 can be decelerated at a constant acceleration in the middle of the deceleration section Zd, that is, after the start of deceleration of the vehicle 100 and before the stop of the vehicle 100. Therefore, depending on the length of the deceleration section Zd, the vehicle 100 can be accurately stopped at the target stop position P1 or P2 without deteriorating the riding comfort of the vehicle 100.

Further, in the vehicle control device 10 of the present embodiment, in the jerk profile 15a included in the acceleration setting unit 15, the absolute value of the positive constant value Cp and the absolute value of the negative constant value Cn are equal to each other. As a result, in the acceleration profile 15b, the absolute value of the time change rate when the acceleration increases and the absolute value of the time change rate when the acceleration decreases can be made equal to each other, and the riding comfort of the vehicle 100 during parking control can be improved.

Further, in the vehicle control device 10 of the present embodiment, the acceleration profile 15b set by the acceleration setting unit 15 is continuous. As a result, the vehicle control device 10 can gradually increase or decrease the inertial force acting on the occupant during parking control of the vehicle 100 to alleviate the impact and improve the riding comfort of the vehicle 100 during parking control.

Further, in the vehicle control device 10 of the present embodiment, the acceleration profile 15b set by the acceleration setting unit 15 is continuous before and after the start of braking. As a result, the vehicle control device 10 can gradually increase the inertial force acting on the occupant at the start of braking of the vehicle 100 to alleviate the impact and improve the riding comfort of the vehicle 100 during parking control.

Further, in the vehicle control device 10 of the present embodiment, the acceleration setting unit 15 includes, for example, the map 15d that records the relationship between the parking start position P0 of the vehicle 100, the target stop positions P1 and P2, and the jerk profile 15a.

The acceleration setting unit 15 is configured to set the acceleration profile 15b based on, for example, the map 15d.

With this configuration, the computing amount of the acceleration setting unit 15 can be reduced, and the acceleration profile 15b can be set quickly.

Further, in the vehicle control device 10 of the present embodiment, the acceleration setting unit 15 includes, for example, the computing unit 15e that calculates the acceleration profile 15b, and is configured to set the acceleration profile 15b calculated by the computing unit 15e. With this configuration, the acceleration setting unit 15 can calculate the acceleration profile 15b by the computing unit 15e based on, for example, the parking start position P0 of the vehicle 100, the target stop position P1 or P2, and the jerk profile 15a, and can set the acceleration profile 15b.

Further, the vehicle control device 10 of the present embodiment includes the route generation unit 13 that generates the target route Rt from the parking start position P0 of the vehicle 100 to the target stop position P1 or P2. Further, the vehicle control device 10 includes, for example, the travel control unit 16 that causes the vehicle 100 to travel according to the acceleration profile 15b and the target route Rt. The travel control unit 16 is configured to calculate the acceleration section Za, the constant speed section Zc, and the deceleration section Zd in the target route Rt, and start braking at the start position of the deceleration section Zd.

With this configuration, according to the acceleration profile 15b, the vehicle 100 is gently accelerated in the acceleration section Za of the target route Rt, caused to travel at a constant speed in the constant speed section Zc, and gradually decelerated in the deceleration section Zd, so that the riding comfort of the vehicle 100 can be improved.

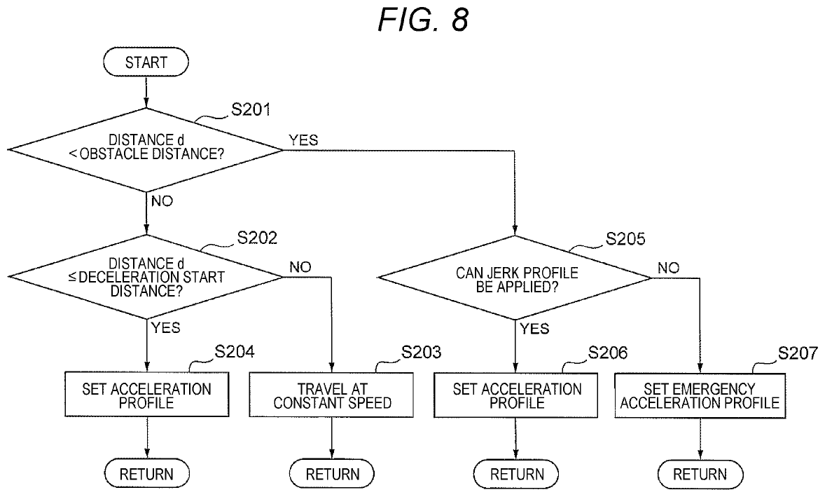

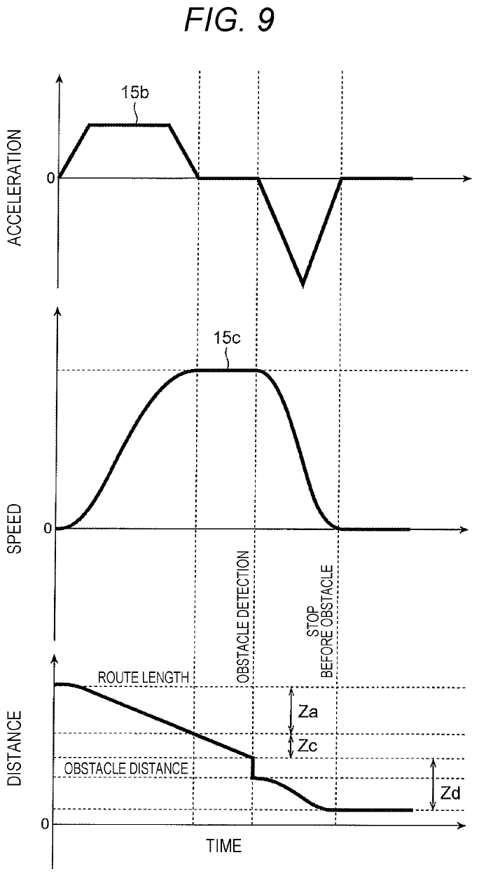

FIG. 7 is a plan view illustrating another example of parking control of the vehicle 100 by the vehicle control device 10 illustrated in FIG. 2. FIG. 8 is a flow chart of parking control of the vehicle 100 by the vehicle control device 10 in the example illustrated in FIG. 7. FIG. 9 is a graph showing time change of the acceleration and speed of the vehicle 100 illustrated in FIG. 7 and the distance d from the position P of the vehicle 100 to the target stop position P1 or the obstacle O.

In the example illustrated in FIG. 7, the vehicle 100 is stopped at the parking start position P0 as in the example illustrated in FIG. 3. Then, the vehicle control device 10 calculates the target stop position P1, the target route Rt, and the target stop position P2 as in the example illustrated in FIG. 3, and sets the acceleration profile 15b based on the jerk profile 15a as shown in FIG. 5.

After that, as in the example illustrated in FIG. 3, when the automatic parking control of the vehicle 100 by the vehicle control device 10 is started, the travel control unit 16 calculates the speed profile 15c shown in FIG. 5 based on the acceleration profile 15b set by the acceleration setting unit 15. Then, the travel control unit 16 controls the engine 1, the automatic transmission 2, the brake 7, and the electric power steering 8 to cause the vehicle 100 to travel according to the jerk profile 15a and the target route Rt. Then, the vehicle control device 10 starts the parking control flow illustrated in FIG. 8.

In step S201, the vehicle control device 10 determines whether or not the obstacle distance, which is the distance from the position P of the vehicle 100 to the obstacle O, is longer than the distance d from the position P of the vehicle 100 to the target stop position P1. When the obstacle O is not detected by the recognition unit 11 in step S201, the vehicle control device 10 determines that the distance d is equal to or longer than the obstacle distance (NO), and the process proceeds to step S202.

In step S202, the vehicle control device 10 accelerates the vehicle 100 by the continuous acceleration profile 15b based on the jerk profile 15a in the acceleration section Za of the target route Rt by the travel control unit 16, and causes the vehicle 100 to travel at a constant speed in the constant speed section Zc of the target route Rt. Further, in step S202, the vehicle control device 10 determines whether or not the distance d is equal to or shorter than the deceleration start distance by, for example, the travel control unit 16.

When it is determined in step S202 that the distance d is not equal to or shorter than the deceleration start distance (NO), the process proceeds to step S203. In step S203, the vehicle control device 10 causes the vehicle 100 to travel at a constant speed by the travel control unit 16, and the process returns to step S201.

In step S201, it is assumed that the obstacle O illustrated in FIG. 7 is detected by the monocular cameras 22 or the sonars 23 of the vehicle 100, and the obstacle O is recognized by the recognition unit 11. Then, the vehicle control device 10 calculates, for example, the distance d from the position P of the vehicle 100 to the obstacle O by the distance measuring unit 14. It is determined whether or not the obstacle distance, which is the distance from the position P of the vehicle 100 to the obstacle O, is longer than the distance d from the position P of the vehicle 100 to the target stop position P1. When the vehicle control device 10 determines that the obstacle distance is longer than the distance d (NO), that is, the vehicle 100 does not collide with the obstacle O, the process proceeds to step S202.

In step S202, for example, when the travel control unit 16 determines that the distance d is longer than the deceleration start distance, that is, the distance d is not equal to or shorter than the deceleration start distance (NO), the process proceeds to step S203. In step S203, the vehicle control device 10 causes the vehicle 100 to travel at a constant speed by the travel control unit 16, and the process returns to step S201.

On the other hand, in step S202, for example, when the travel control unit 16 determines that the distance d is equal to or shorter than the deceleration start distance (YES), the process proceeds to step S204. In step S204, the vehicle control device 10 sets the acceleration profile 15b based on the jerk profile 15a by the acceleration setting unit 15.

The travel control unit 16 decelerates the vehicle 100 according to the set acceleration profile 15b, and stops the vehicle 100 at the target stop position Pl. As a result, as in the example shown in FIG. 5, the vehicle control device 10 can gradually increase or decrease the inertial force acting on the occupant at the start and end of braking of the vehicle 100 to alleviate the impact and improve the riding comfort of the vehicle 100 during parking control.

Further, in step S201, when the obstacle O is recognized by the recognition unit 11, and it is determined that the obstacle distance is shorter than the distance d from the position P of the vehicle 100 to the target stop position P1 by the vehicle control device 10 (YES), that is, the vehicle 100 may collide with the obstacle O, the process proceeds to step S205. Here, the distance shown in the graph at the bottom of FIG. 9 is set as the obstacle distance from the position P of the vehicle 100 to the obstacle O. That is, the position where the distance becomes 0 is the position where the vehicle 100 and the obstacle O come into contact with each other.

In step S205, the vehicle control device 10 determines, for example, whether or not the jerk profile 15a can be applied by the acceleration setting unit 15 based on whether or not collision avoidance between the vehicle 100 and the obstacle O is possible. The vehicle control device 10 proceeds to step S206 when it is determined that the jerk profile 15a is applied and collision avoidance is possible (YES), and proceeds to step S207 when it is determined that collision avoidance is impossible (NO) when the jerk profile 15a is applied.

In step S206, the vehicle control device 10 sets the acceleration profile 15b based on the jerk profile 15a by the acceleration setting unit 15. The travel control unit 16 decelerates the vehicle 100 according to the set acceleration profile 15b, and stops the vehicle 100 at the stop position P3 before the obstacle O. As a result, as shown in FIG. 9, the vehicle control device 10 can gradually increase or decrease the inertial force acting on the occupant at the start and end of braking of the vehicle 100 to alleviate the impact and improve the riding comfort of the vehicle 100 during parking control.

On the other hand, in step S207, which is a case of an emergency requiring a sudden stop, the vehicle control device 10 sets the emergency acceleration profile 15z independent of the jerk profile 15a by the acceleration setting unit 15 as shown in FIG. 4. The travel control unit 16 suddenly stops the vehicle 100 according to the set emergency acceleration profile 15z, and stops the vehicle 100 at the stop position P3 before the obstacle O. As a result, it is possible to avoid a collision between the vehicle 100 and the obstacle O.

As described above, the vehicle control device 10 of the present embodiment includes the recognition unit 11 that recognizes the obstacle O around the vehicle 100, and the stop position calculation unit 12 that calculates the stop position P3 for avoiding a collision with the obstacle O. Then, the acceleration setting unit 15 is configured to set the time of starting braking based on the stop position P3.

With this configuration, it is possible to start braking the vehicle 100 according to the distance d between the stop position P3 and the vehicle 100, improve the riding comfort of the vehicle 100, and avoid a collision with the vehicle 100.

Further, in the vehicle control device 10 of the present embodiment, the acceleration setting unit 15 is configured to set the emergency acceleration profile 15z independent of the jerk profile 15a in an emergency requiring a sudden stop, for example. As a result, in an emergency, the vehicle 100 can be suddenly stopped with priority given to safety over the riding comfort, and a collision between the vehicle 100 and the obstacle O can be avoided.

Further, the vehicle control device 10 of the present embodiment can calculate a return route Rr for returning to the target route Rt from the stop position P3 to the target stop position P1 as illustrated in FIG. 7, for example, by the route generation unit 13. In this case, the acceleration setting unit 15 sets the acceleration profile 15b based on the jerk profile 15a, and the travel control unit 16 moves the vehicle 100 backward according to the return route Rr and the acceleration profile 15b.

As described above, according to the present embodiment, it is possible to provide the vehicle control device 10 capable of improving the riding comfort of the vehicle 100 during parking control.

Although the vehicle control device according to the embodiment of the present disclosure has been described above in detail with reference to the drawings, the specific configuration is not limited to this embodiment, and if the design changes and the like are made so as not to be deviated from the gist of the present disclosure, they are included in this disclosure.

### REFERENCE SIGNS LIST

10 vehicle control device

11 recognition unit

12 stop position calculation unit

13 route generation unit

14 distance measuring unit

15 acceleration setting unit

15a jerk profile

15b acceleration profile

15d map

15e computing unit

15z emergency acceleration profile

16 travel control unit

100 vehicle

Cp positive constant value

Cn negative constant value

d distance

O obstacle

P position

P0 parking start position

P1 target stop position

P2 target stop position

P3 stop position

Sn section

Sp section

Sz section

Rt target route

Za acceleration section

Zc constant speed section

Zd deceleration section

1. A vehicle control device, comprising:
a distance measuring unit that measures a distance between a position of a vehicle and a target stop position of the vehicle; and
an acceleration setting unit that sets an acceleration profile, which is a time change of a target value of acceleration during deceleration of the vehicle, according to the distance based on a jerk profile, which is a time change of a target value of jerk during deceleration of the vehicle.

2. The vehicle control device according to claim 1, wherein the jerk profile has a section in which the target value of the jerk is a constant positive value.

3. The vehicle control device according to claim 2, wherein the jerk profile has a section in which the target value of the jerk is a constant negative value.

4. The vehicle control device according to claim 2, wherein the jerk profile has a section in which the target value of the jerk is 0.

5. The vehicle control device according to claim 3, wherein an absolute value of the constant positive value and an absolute value of the constant negative value are equal to each other.

6. The vehicle control device according to claim 1, wherein the acceleration profile is continuous.

7. The vehicle control device according to claim 1, wherein the acceleration profile is continuous before and after start of braking.

8. The vehicle control device according to claim 6, further comprising:
a recognition unit that recognizes an obstacle around the vehicle; and
a stop position calculation unit that calculates a stop position for avoiding a collision with the obstacle,
wherein the acceleration setting unit sets a time of starting braking based on the stop position.

9. The vehicle control device according to claim 6, further comprising:
a route generation unit that generates a target route from a parking start position of the vehicle to the target stop position; and
a travel control unit that causes the vehicle to travel according to the acceleration profile and the target route,
wherein the travel control unit calculates an acceleration section, a constant speed section, and a deceleration section in the target route, and starts braking at a start position of the deceleration section.

10. The vehicle control device according to claim 1, wherein the acceleration setting unit includes a map that records a relationship between a parking start position of the vehicle, the target stop position, and the jerk profile, and sets the acceleration profile based on the map.

11. The vehicle control device according to claim 1, wherein the acceleration setting unit includes a computing unit that calculates the acceleration profile, and sets the acceleration profile calculated by the computing unit.

12. The vehicle control device according to claim 1, wherein the acceleration setting unit sets an emergency acceleration profile independent of the jerk profile in an emergency requiring a sudden stop.
